(19) United States
(12) Patent Application Publication
(10) Pub. No.: US 2012/0260309 A1
(43) Pub. Date: Oct. 11, 2012

(54) System for Managing Real Time Ad-Hoc Service Relationships Between Services and Network Attached Client Devices

(75) Inventors: Michael Hathaway, Austin, TX (US); Christopher Wilder, Volente, TX (US)

(73) Assignee: PICO ENERGY SERVICES, INC., Volente, TX (US)

(21) Appl. No.: 13/415,096

(22) Filed: Mar. 8, 2012

Related U.S. Application Data
(63) Continuation of application No. 12/566,603, filed on Sep. 24, 2009, now abandoned.
(60) Provisional application No. 61/099,892, filed on Sep. 24, 2008.

(51) Int. Cl. G06F 21/00; G06F 15/16

(52) U.S. Cl. 726/3

(57) ABSTRACT

A system comprising network based servers and a data management system providing a unified method for managing real time ad-hoc service relationships between service providers and network attached devices connected directly to the network or attached to a network attached premises gateway. Functions of a system include device/gateway network address discovery, transaction and access security, access permissions between elements in a service network and tracking of transactions between network elements.

### CROSS-REFERENCE TO RELATED APPLICATIONS

The present application is related to and claims the benefit of provisional patent application 61/099,892, filed Sep. 24, 2008. All subject matter of the provisional application is incorporated herein by reference to the extent such subject matter is not inconsistent herewith.

### SUMMARY

In one aspect, a method for data management includes managing one or more ad-hoc service relationships in one or more computer servers, me managing between one or more service providers and one or more client devices, the managing including identifying each service required by each service provider with a service related unique identifier, identifying each client device of the one or more client devices with a client device related unique identifier; and managing data associated with the one or more ad-hoc service relationships using one or more of the service related unique identifiers and the one or more client device related unique identifiers; and authenticating via a service portal the one or more ad-hoc service relationships including authenticating interactions between the one or more service providers and the one or more client devices.

In another aspect, a computer program, product including a computer readable medium configured to perform one or more acts for performing management of ad-hoc service relationships includes one or more instructions for managing one or more ad-hoc service relationships in one or more computer servers, the managing between one or more service providers and one or more client devices, the managing including one or more instructions for identifying each service required by each service provider with a service related unique identifier; one or more instructions for identifying each client device of the one or more client devices with a client device related unique identifier; and one or more instructions for managing data associated with the one or more ad-hoc service relationships using one or more of the service related unique identifiers and the one or more client device related unique identifiers; and one or more instructions for authenticating via a service portal the one or more ad-hoc service relationships including, authenticating interactions between the one or more service providers and the one or more client devices.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIG. 1 is a flow diagram in accordance with an embodiment of the present invention.

FIG. 2 is a flow diagram in accordance with an embodiment of the present invention.

FIG. 3 is a flow diagram in accordance with an embodiment of the present invention.

FIG. 4 is a block diagram of an exemplary computer architecture that supports the claimed subject matter.

### DETAILED DESCRIPTION

In the following detailed description, reference is made to the accompanying drawings, which form a part thereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

A system according to embodiments herein can operate as a network-based trusted third party authority that provides a unified method for service elements to establish ad-hoc service relationships for delivering information and communications services over a data network.

The network elements within a system can include Services, Client Devices, Network Server, Service Portal and a Data Management System.

Services: Include network based software applications, communications services or information services accessible via network attached Client Devices

Client Device: Include network-attached devices or network attached gateways which connect multiple devices within a premises to a network.

Network Servers: The system according to an embodiment utilizes at least two types of Network Servers operating as a trusted third party authority between services and client devices.

Access Servers: Access Servers manage access privileges and permissions between Services and Client Devices, Access Servers operate like a domain name server (DNS) which, in addition to associating a network address to a unique name or NetID, also provides access profile data specific to the requesting Service.

Transaction Servers: Transaction Servers provide transaction IDs for the purpose Of tracking transactions between one or more service and client devices. A Transaction. Server issues a unique Transaction ID upon request from a Service directly or indirectly via the Access Server. The Transaction ID (TX-TD) can be used by Services and Client Devices to report Transaction progress in order to track and log transactions between Services and Client Devices.

Service Portal: A Service Portal accessible via a secure Internet web interlace or web services interface provides a means for the client (owner of devices or premises) to set and manage service preferences including service access permissions, service subscriptions and client profile information (billing, identity, security settings).

Data Management System: A real time data management system that manages information regarding relationships between client and services including device or premises network access information and permissions, service preferences, service and device profiles, service and client identities, transaction information and security access and encryption information. A data management system provides real time service related information to Access Senders pertaining to service relationships between one or more Services and Client Devices using the System. In addition the Data Management System stores real time transaction information including unique transaction IDs (TX-TD) issued by Transaction Servers requested by a Service or Device initiating a transaction as well as transaction status reported to Transaction Servers by Client Devices and Service.

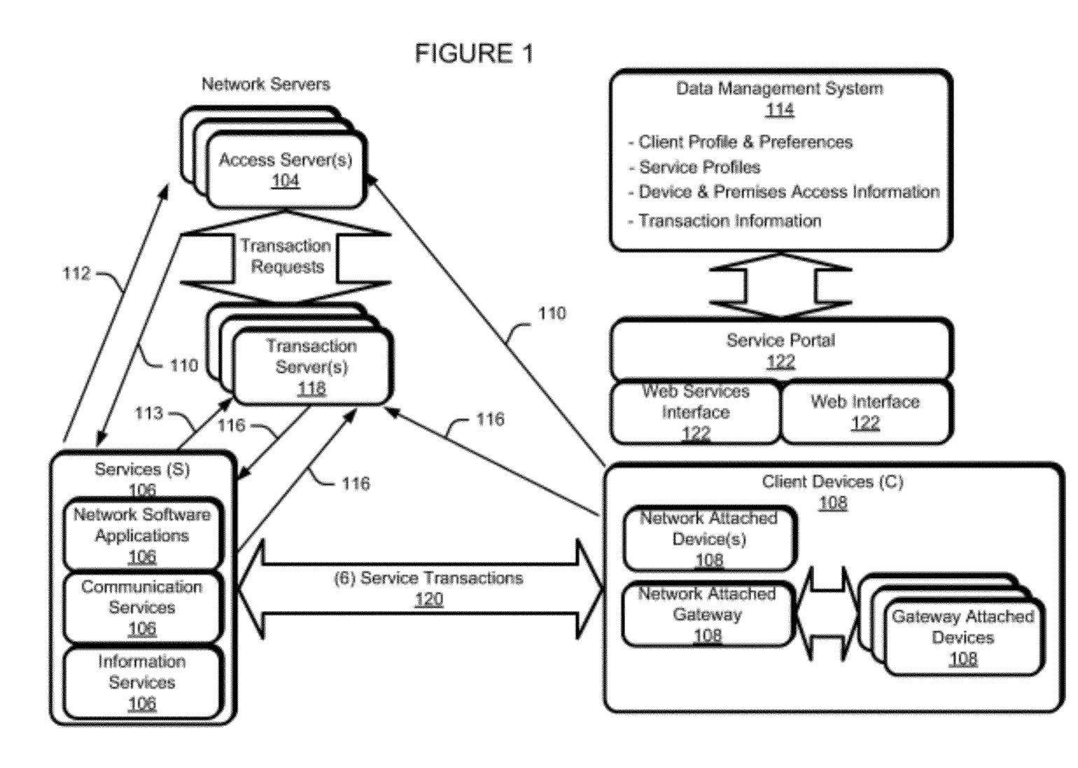

Referring to FIG. 1, Access Server 104 is accessible by Service 106 via an encrypted, session oriented network protocol such as SSL using an identifier such as a login ID or certificate which uniquely identifies the identity of Service 106. An access key may identify a specific Element of Service 106. There may be more than one element of Service 106.

When Client Device or Gateway (C) 108 connects to a network, it registers with Access Server 104 and provides network address (NetID) 110 which is associated with Device or Gateway's 108 unique. ID (C-ID) and any other unique references used to identify the client device, premises or gateway.

Network Service (S) 106 requests access of Client Device or Gateway (C) 108 by issuing Access Request 112, which can optionally include new Transaction Request (TXReq) 113. A request uses the unique ID for Client Device 108 (C-TD) or another unique reference registered with Access Server 104 for the target. Because Service (S) 106 uses its secure login information to access Access Server 104, its unique identity is known and used to reference the necessary service profile information from Data Management System 114.

Access Server 104 retrieves the Service Profile data that defines service permissions and relationships between Client Devices (C) 108 and Services (S) 306. A Service Profile contains service permissions and access keys and codes for any Services Client Devices (C) 108 have allowed for requesting Service (S) 106 to gain access to. Access Server 104 returns A profile information along with network address (Net ID) 110 of Client Device (C) 108, as well as Transaction ID (TX-ID) 116 if it was optionally requested.

If requesting Service (S) 106 requests Transaction ID (TX-ID) 116 as a separate operation, it does so providing Client ID (C-ID) as a reference to Transaction Server 118.

Transaction Server 118 returns unique Transaction ID (TX-ID) 116 to requesting Service (S) 106 that will be used to reference all transactions related to that transaction with any Services 106 or Client Devices 108 involved in that, transaction.

Service Transaction 120 is performed over a network using the access profile information and any Transaction ID (TX-ID) 116 associated with the transaction.

Client Devices 108 and Services 106 involved in a transaction provide Transaction Server 118 with Transaction Status as they complete their steps in the transaction. Additionally, Service Portal, Web Services Interface, and Web Interface 122 may allow a user to access Data Management System 114.

System Applications

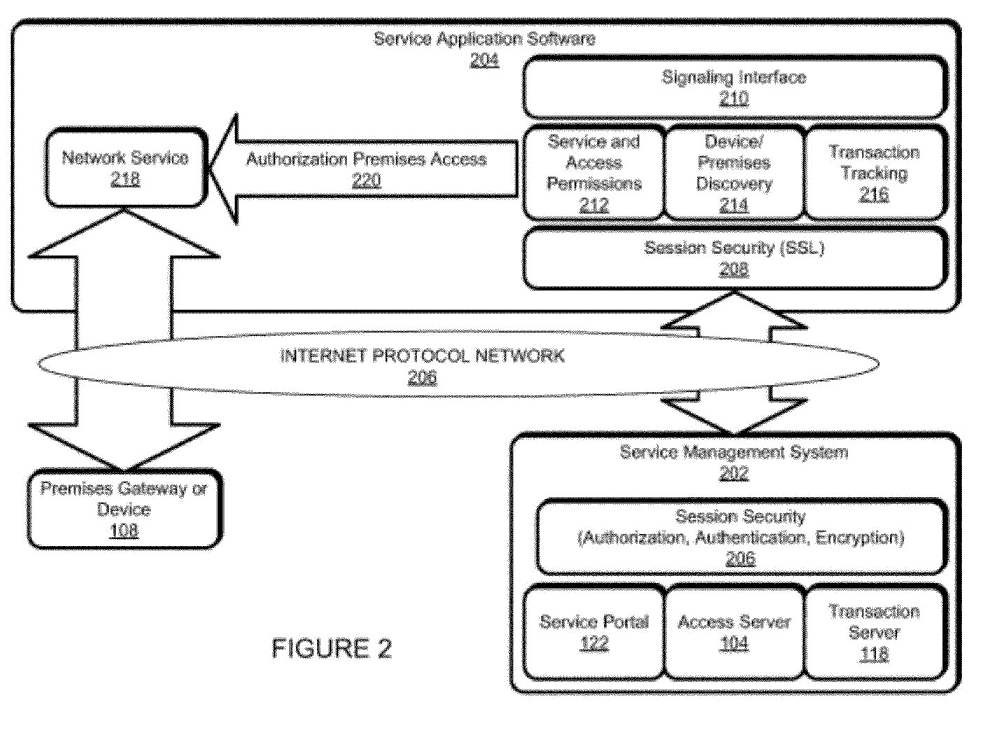

Referring to FIG. 2, the system is designed to provide efficient atomic operations that can be integrated into a service or application program interface (API) to negotiate service interactions with customer devices, and other services to create new, integrated service options for a service client. In an embodiment, Client Device 108 and Service Management System 202 communicate to Service Application Software 204 over Internet Protocol Network 206. Service Management System 202 can operate as a trusted, third party authority that provides Service Application Software 204 a unified method to exchange information needed to securely access Client Devices (C) 108 in order to transact information or communications services. Network accessible Data Management System 114 unifies the management of service relationships between client and service providers as an alternative to enterprise-based services that restrict the management of service relationships to a specific service application or service provider.

Service Management System 202 includes Session Security 206 to provide authorization, authentication, and encryption. Service Management System 202 also includes Service Portal 122 to allow user access to set and manage service preferences including service access permissions, service subscriptions and client profile information (billing, identity, and security settings) in Data Management System 114. Service Management System 202 also includes Access Server 104 and Transaction Server 118

Service Application Software 204 includes Session Security 208 and Signaling Interface 210 that allow Service Application Software 204 to interact with Service Management System 202. Service Application Software 204 also implements Service and Access Permissions 212, Device/Premises Discovery 214, and Transaction Tracking 216, which communicate with Network Service 218 through Authorization Premises Access 220.

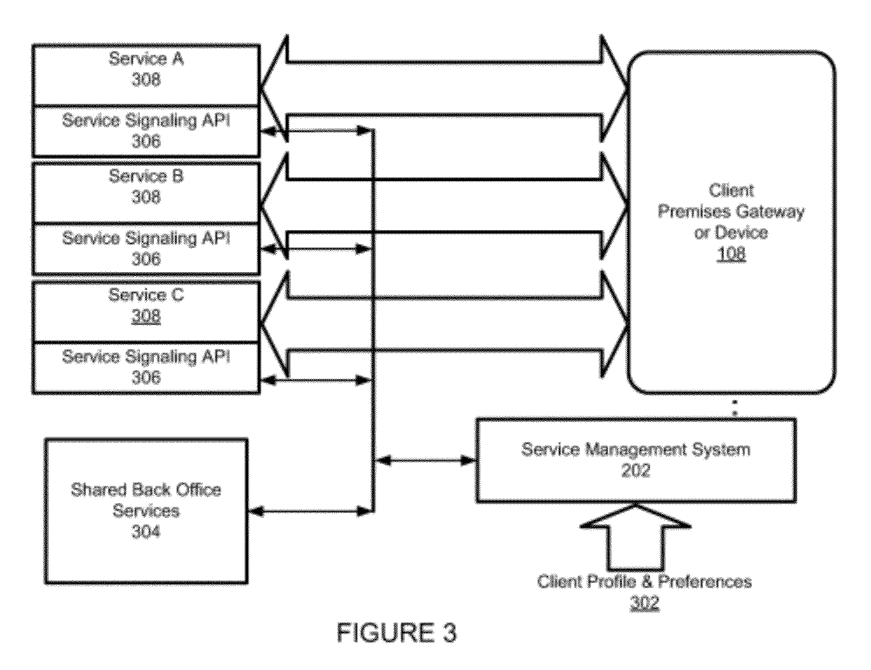

Service providers can use the System to establish ad-hoc relationships with other service providers. As depicted in FIG. 3, these relationships include, shared hack office services like unified billing, or enable the sharing of service delivery data to integrate services or create new services or bundled services in an ad-hoc manner. Service Management System 202 can utilize its secure and authenticated signaling capabilities to operate as secure information exchange between service providers. Client Profile and Preferences 302 are maintained in Service Management System 202. Shared Back Office Services 304 may provide information used for Service Signaling API 306 to enable Service 308 to interact with Client Devices 108.

Service Management System 202 enables the interoperation of a diverse set of services creating new-service opportunities to clients by providing a unified method for identifying and characterizing service entities and integrating these associations into a scalable network service, thereby
Eliminating the need for point to point security connections.
Reducing the time it takes operators to integrate new services.
Providing service client with a centralized means to manage third party service preferences, options and service relationships.

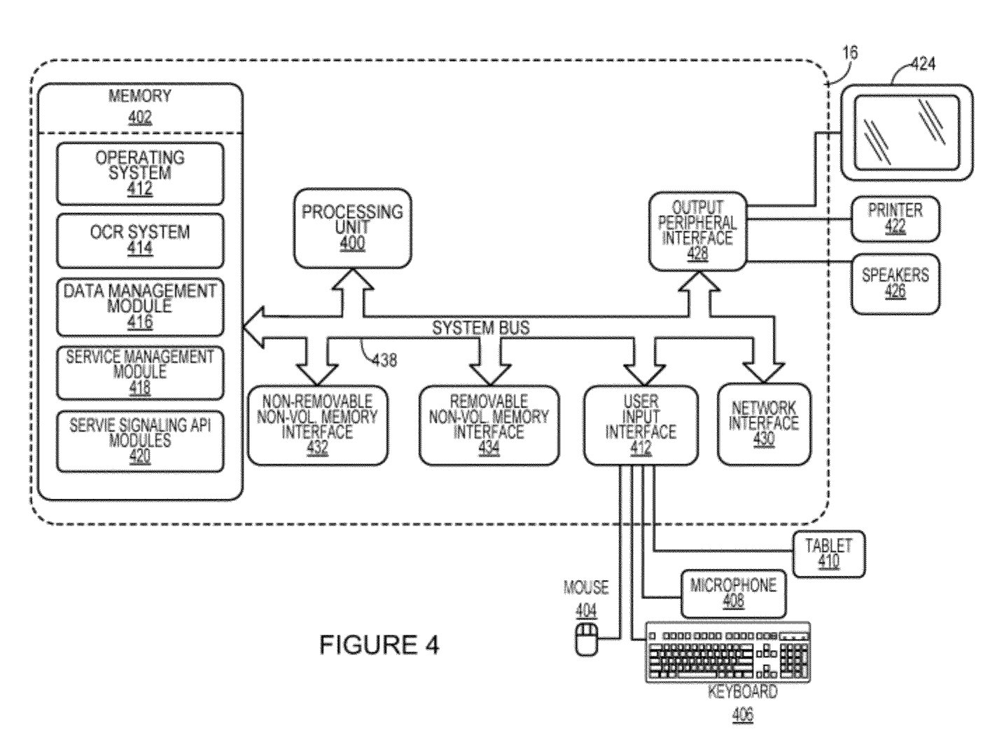

Referring to FIG. 4, a general purpose computer that can operate as one or more of Access Server 104 (or Transaction Server 118), as shown in FIG. 1. Access Server 104 includes, but is not limited to, one or more of a personal computer (PC), workstation. Laptop, personal digital assistant (PDA), palm device, and the like. Generally, in terms of hardware architecture, as shown in FIG. 4, Access Server 104 includes a processor or processing unit 400 and memory 402.

Access Server 104 further includes one or more user input devices, such, as a mouse. 404, keyboard 406, microphone 408, and tablet 410, through which a user may enter commands and data and output devices. The input and output (I/O) devices can be connected to the processing unit 400 through a user input interlace 412. The user input interface 412 can be, for example, but not limited to, one or more buses or other wired or wireless connections, as is known in the art (such as a parallel port, game port, or a universal serial bus (USB)). The user input interface 412 may have additional elements, which are omitted for simplicity, such as controllers, buffers (caches), drivers, repeaters, and receivers, to enable communications. Further, the user input interfaced 412 may include address, control, and/or data connections to enable appropriate communications among the aforementioned components.

The processing unit 400 can be a hardware device for executing software that can be stored in the memory 402. The processing unit 400 110 can be virtually any custom made or commercially available, processor, a central processing unit (CPU), data signal processor (DSP) or an auxiliary processor among several processors associated with Access Server 104, and a semiconductor based microprocessor (in the form of a microchip) or a macroprocessor. Examples of suitable commercially available microprocessors are as follows: an 80×86 or Pentium series microprocessor from Intel Corporation, U.S.A., a PowerPC microprocessor from IBM, U.S.A., a Spare microprocessor from Sun Microsystems, Inc, a PA-RISC series microprocessor from Hewlett-Packard Company, U.S.A., or a 68xxx series microprocessor from Motorola Corporation, U.S.A.

The memory 402 can include anyone or combination of volatile memory elements (e.g., random access memory (RAM, such as dynamic random access memory (DRAM), static random access memory (SRAM), etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 402 may incorporate electronic, magnetic, optical, and/or other types of storage media. Note that the memory 402 can have a distributed architecture, where various components are situated remote from one another, but can be accessed by the processor 110.

The software in memory 402 can include one or more separate programs, each of which comprises an ordered listing of executable instructions for implementing logical functions. In the example illustrated in FIG. 4, the software in the memory 402 includes a suitable operating system (O/S) 412, an OCR system 414, new vehicle system 416, information delivery system 418, and update database system 420.

A non-exhaustive list of examples of suitable commercially available operating systems 412 is as follows (a) a Windows Operating system available from Microsoft Corporation; (b) a Netware operating system available from Novell, Inc.; (c) a Macintosh operating system available from Apple Computer, Inc.; (d) a UNIX operating, system, which is available for purchase from many vendors, such as the Hewlett-Packard Company, Sun Microsystems. Inc., and AT&T Corporation; (e) a LINUX operating system, which is freeware that is readily available on the Internet; (f) a run time Vx works operating system from WindRiver Systems, Inc.; or (g) an appliance-based operating system, such as that implemented: in handheld computers or personal data assistants (PDAs) (e.g., Symbian OS available from Symbian, Inc., PalmOS available from Palm Computing, Inc., and Windows CE available from Microsoft Corporation).

The operating system 412 essentially controls the execution of other computer programs, such as shared services system 414, data management module 416, service management module 418, and service signaling API modules 420. The hared services system 414, data management module 416, service management module 418, and service signaling API modules 420 may be a source program, executable program (object code), Script. Or any other entity comprising a Set of instructions to be performed. When a source program, the program is usually translated via a compiler, assembler, interpreter, or the like, which may or may not be included within the memory 402, so as to operate properly in connection with the O/S 412. Furthermore, hared services system 414, data management module 416, service management module 418, and service signaling API modules 420 can be written as (a) an object oriented programming language, which has classes of data and methods, or (b) a procedure programming language, which has routines, subroutines, and/or functions, for example but not limited to, C, C++, Of, Pascal, BASIC, API calls, HTML, XHTML, XML, ASP scripts, FORTRAN, COBOL, Perl, Java, ADA, .NET, and the like.

Furthermore, the I/O devices may also include output device, for example but not limited to, a printer 422, display 424, speakers 426, etc. The I/O devices communicate through art output peripheral interface 428.

Finally, the I/O devices may further include devices that communicate both inputs and outputs, for instance but not limited to, a NIC 239 or modulator/demodulator (for accessing remote devices, other files, devices, systems, or a network), a radio frequency (RF) or other transceiver (not shown), a telephonic interface (not shown), a bridge (not shown), a router (not shown), etc.

If Access Server 104 is a PC, workstation, intelligent device, or the like, the software in: the memory 402 may further include a basic input output system (BIOS) (omitted for simplicity). The BIOS is a set of essential software routines that initialize and test hardware at startup, start the O/S 412, and support the transfer of data among the hardware devices. The BIOS is stored in some type of read-only-memory, such as ROM, PROM, EPROM, EEPROM or the like, so that the BIOS can be executed when Access Server 104 is activated.

When Access Server 104 is in operation, the processing unit 400 is configured to execute software stored within the memory 402, to communicate data to and from the memory 402, and to generally control operations of Access Server 104 are pursuant to the software. The shared services system 414, data management module 416, service management module 418, and service signaling API modules 420 and the O/S 412 are read, in whole or in part, by the processing unit 420, and can be buffered within the processing unit 400, and then executed.

When the systems 414, 416, 418 and 420 are implemented in software, as is shown in FIG. 4, it should be noted that the routines for such systems can be stored on virtually any computer readable medium for use by or in connection with any computer related system or method. The systems 414, 416, 418 and 420 can be embodied in any computer-readable medium for use by or in connection with an instruction execution system, apparatus, or device, such as a computer-based system, processor-containing System, or other system that can fetch the instructions from; the instruction execution system, apparatus, or device and execute the instructions. In the context of this document, a “computer-readable medium” can be any means that can store, contain, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium.

More specific examples (a nonexhaustive list) of the computer-readable medium include the following; an electrical connection (electronic) having one or more wires, a portable computer diskette (magnetic or optical), a random access memory (RAM) (electronic), a read-only memory (ROM) (electronic), an erasable programmable read-only memory (EPROM, EEPROM, or Flash memory) (electronic), an optical fiber (optical), and a portable compact disc memory (CDROM, CD R/W) (optical). Note that the computer-readable medium could even be paper or another suitable medium, upon which the program is printed or punched, as the program can be electronically captured, via for instance optical scanning of the paper or other medium, then compiled, interpreted or otherwise processed in a suitable manner if necessary, and then stored in a computer memory. Non-removable non-volatile memory interlace 432 and removable non-volatile memory interface 434 can be used to accesses such computer readable memory, in this example, system bus 438 connects the processing unit 400, memory 402, user input interface 412, output peripheral interface 428, network interface 430, non-removable non-volatile memory interface 432, and removable non-volatile memory interface 434

In an alternative embodiment, where the system is implemented in hardware, the modules can be implemented with any one or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Those having skill in the art will recognize that the state of the art has progressed to the point where there is little distinction left between hardware, software, and/or firm-ware implementations of aspects of systems; the use of hardware, software, and/or firmware is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility Is paramount, the implementer may opt for a mainly software implementation: or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g. speed, flexibility, or predictability) of the implementer, any of which may vary. Those skilled in the art will recognize that optical aspects of implementations will typically employ optically-oriented hardware, software, and or firmware.

In some implementations described herein, logic and similar implementations may include software or other control structures suitable to operation. Electronic circuitry, for example, may manifest one or more paths of electrical current constructed and arranged to implement various logic functions as described herein, In some implementations, one or more media are configured to bear a device-detectable implementation if such media hold or transmit a special-purpose device instruction set operable to perform as described herein. In some variants, for example, this may manifest as an update or other modification of existing software or firmware, or of gate arrays or other programmable hardware. Such as by performing a reception of or a transmission of one or more instructions in relation to one or more operations described herein. Alternatively or additionally, in some variants, an implementation may include special-purpose hardware, software, firmware components, and/or general-purpose components executing or otherwise invoking special-purpose components. Specifications or other implementations may be transmitted by one or more instances of tangible transmission media as described herein, optionally by packet transmission or otherwise by passing through distributed media at various times.

Alternatively or additionally, implementations may include executing a special-purpose instruction sequence or otherwise invoking circuitry for enabling, triggering, coordinating, requesting, or otherwise causing one or more occurrences of any functional operations described above. In some variants, operational or other logical descriptions herein may be expressed directly as source code and compiled or otherwise invoked as an executable instruction sequence. In some contexts, for example, C++ or other code sequences can be compiled directly or otherwise implemented in high-level descriptor languages (e.g., a logic-synthesizable language, a hardware description language, a hardware design simulation, and/or other such similar mode(s) of expression). Alternatively or additionally, some or all of the logical expression may be manifested as a Verilog-type hardware description or oilier circuitry model before physical implementation in hardware, especially for basic operations or timing-critical applications. Those skilled in the art will recognise how to obtain, configure, and optimize suitable transmission or computational elements, material supplies, actuators, or other common structures in light of these teachings.

The foregoing detailed description has set forth various embodiments of the devices and/or processes via the use of block diagrams, flowcharts, and/or examples, Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the an will recognise that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiberoptic cable, a waveguide, a wired communications link, a wireless communication link (e.g., transmitter, receiver, transmission, logic, reception logic, etc.).

With respect to the use of substantially any plural and/or singular terms herein, those having skill in the art can translate from the plural to the singular and/or from the singular to the plural as is appropriate to the context and/or application. The various singular/plural permutations are not expressly set forth herein forsake of clarity.

The herein described subject matter sometimes illustrates different components contained within, or connected with, different other components. It is to be understood that such depicted architectures are merely exemplary, and that in fact many oilier architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being, “operably couplable”, to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components.

In some instances, one or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g. the term “including” should be interpreted as “including but not limited to,” the term “having” should be interpreted as “having; at least,” the term “includes” should be interpreted as “includes but is not limited to.” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim, containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include, but not be limited to systems that have A alone, B alone, C alone, A and B together, A and C together, B and C together, and/or A, B, and C together, etc.). In those instances where a convention analogous to “at least one of A, B, or C, etc.” is used, in general such a construction Is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms. For example, the phrase “A or B” will be typically understood to include the possibilities of “A” or “B” or “A and B.”

In a general sense, those skilled in the art will recognize that the various aspects described herein which can be implemented, individually and/or collectively, by a wide range of hardware, software, firmware, and/or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), and/or electrical circuitry forming a communications device (e.g., a modem, communications switch, optical-electrical equipment, etc). Those having skill in the art will recognize that the subject matter described herein may be implemented in an analog or digital fashion or some combination thereof.

With respect to the appended claims, those skilled in the art will appreciate that recited operations therein may generally be performed in any order. Also, although various operational flows are presented in a sequence(s), it should be understood that the various operations may be performed in other orders than those that are illustrated, or may be perforated concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to” or other past-tense adjectives are generally not intended to exclude such variants, unless context dictates otherwise.

Although specific dependencies have been identified in the claims, it is to be noted that all possible combinations of the features of the claims are envisaged in the present application, and therefore the claims are to be interpreted to include ail possible multiple dependencies.

We claim:

1. A method for data management, the method comprising:
managing one or more ad-hoc service relationships in one or more computer servers, the managing between one or more service providers and one or more client devices, the managing including
identifying each service required by each service provider with a service related unique identifier;
identifying each client device of the one or more client devices with a client device related unique identifier; and
managing data associated with the one or more ad-hoc service relationships using one or more of the service related unique identifiers and the one or more client device related unique identifiers; and
authenticating via a service portal the one or more ad-hoc service relationships including authenticating interactions between the one or more service providers and the one or more client devices.

2. A computer program product comprising a computer readable medium configured to perform one or more acts for performing management of ad-hoc service relationships the one or more acts comprising:
one or more instructions for managing one or more ad-hoc service relationships in one or more computer servers, the managing between one or more service providers and one or more client devices, the managing including
one or more instructions for identifying each service required by each, service provider with a service related unique identifier;
one or more instructions for identifying each client device of the one or more client devices with a client device related unique identifier; and
one or more instructions for managing data associated with the one or more ad-hoc service relationships using one or more of the service related unique identifiers and the one or more client device related unique identifiers; and
one or more instructions for authenticating via a service portal the one or more ad-hoc service relationships including authenticating interactions between the one or more service providers and the one or more client devices.
